(19) United States
(12) Patent Application Publication
(10) Pub. No.: US 2014/0059652 A1
(43) Pub. Date: Feb. 27, 2014

(54) APPARATUS FOR UPLOADING CONTENTS, USER TERMINAL APPARATUS FOR DOWNLOADING CONTENTS, SERVER, CONTENTS SHARING SYSTEM AND THEIR CONTENTS SHARING METHOD

(71) Applicant: SAMSUNG ELECTRONICS CO., LTD., Suwon-si (KR)

(72) Inventors: Won-jong CHOI, Daejeon (KR); Hyung-tak CHOI, Suwon-si (KR); O-hoon KWON, Suwon-si (KR)

(73) Assignee: SAMSUNG ELECTRONICS CO., LTD., Suwon-si (KR)

(21) Appl. No.: 13/974,568

(22) Filed: Aug. 23, 2013

(30) Foreign Application Priority Data
Aug. 23, 2012 (KR) 10-2012-0092610

(51) Int. Cl. H04L 29/06

(52) U.S. Cl. CPC H04L 63/123
USPC 726/4

(57) ABSTRACT

A user terminal apparatus for uploading contents, a user terminal apparatus for downloading contents, a server, a content sharing system, and methods thereof are provided. The contents sharing method includes creating contents, uploading the created contents from the user terminal apparatus to a server, receiving, at the user terminal, storage location information corresponding to a location in the server where the uploaded contents are stored and access authorization information for accessing the uploaded contents from the server, and transmitting a message including the storage location information and the access authorization information from the user terminal apparatus to a second user terminal apparatus.

### CROSS-REFERENCE TO RELATED APPLICATIONS

This application claims priority from Korean Patent Application No. 2012-0092610, filed in the Korean Intellectual Property Office on Aug. 23, 2012, the disclosure of which is incorporated herein by reference.

### BACKGROUND

1. Field

Methods and apparatuses consistent with the exemplary embodiments relate to a user terminal apparatus for uploading contents, user terminal apparatus for downloading contents, server, contents sharing system, and a contents sharing method thereof, and more particularly, to a user terminal apparatus for uploading contents configured to perform contents sharing using storage location information corresponding to a location in a server where contents are stored and access authorization information for accessing the contents, a user terminal apparatus for downloading contents, sever, contents sharing system, and contents sharing method thereof.

2. Description of the Related Art

Due to the development of electronic technologies, various kinds of electronic devices are being developed and distributed. For example, user terminal apparatuses such as high-tech smart phones which are based on new IT technologies are being distributed.

Recently, due to the reduction of prices and improvement of performance of high-tech user terminal apparatuses, demand for high-tech user terminal apparatuses is increasing. Accordingly, efforts to develop various and convenient usage methods suitable to high-tech user terminal apparatuses are being accelerated.

As a result, there needs to be a method for conveniently sharing contents created in user terminal apparatuses with numerous users.

### SUMMARY

Exemplary embodiments provide a user terminal apparatus for uploading contents configured to perform contents sharing using storage location information corresponding to a location in a server where the contents are stored and access authorization information for accessing contents, and a user terminal apparatus for downloading contents, server, contents sharing system, and contents sharing method thereof.

According to an exemplary embodiment, a contents sharing method of a user terminal apparatus for uploading contents may include creating contents; uploading the created contents from the user terminal apparatus to a server; receiving, at the user terminal, storage location information corresponding to a location in the server where the uploaded contents are stored and access authorization information for accessing the uploaded contents from the server; and transmitting a message comprising the storage location information and the access authorization information from the user terminal apparatus to a second user terminal apparatus.

In addition, the storage location information may be uniform resource locater information corresponding to the location in the server where the uploaded contents are stored.

Furthermore, the message may be in at least one from among a multimedia messaging service message, a short messaging service message, an instant message, and an e-mail message.

According to an exemplary embodiment, a contents sharing method of a server may include receiving uploaded contents from a first user terminal apparatus; storing the received contents; generating storage location information corresponding to a location in the server where the received contents are stored and access authorization information for accessing the received contents; transmitting the storage location information and the access authorization information to the first user terminal apparatus; receiving the storage location information and the access authorization information from a second user terminal apparatus which receives the storage location information and the access authorization information from the first user terminal apparatus; and transmitting the received contents to the second user terminal apparatus in response to the receiving.

In addition, the storing may classify and store the received contents based on contents subject, contents type, or user terminal apparatus which uploaded the contents, and the generating may generate the storage location information corresponding to a location in a server where the received contents are classified and stored, and the access authorization information for accessing the classified and stored contents.

According to an exemplary embodiment, a method for sharing contents of a user terminal apparatus for downloading contents may include receiving, at a second user terminal apparatus, a message including storage location information corresponding to a location in a server where contents are stored and access authorization information for accessing the contents from a first user terminal apparatus; accessing the contents uploaded by the first user terminal apparatus to the server by using the storage location information and the access authorization information; and downloading the accessed contents.

In addition, the accessing may be performed by accessing the location in the server where the contents are stored by using the received location information and by transmitting the access authority information to the server.

According to an exemplary embodiment, a contents sharing method of a user terminal apparatus for uploading contents may include creating contents; generating storage location information corresponding to a location in a server where the created contents will be stored and access authorization information for accessing the created contents; combining the storage location information and the access authority information with the created contents and uploading the combined storage location information, the access authority information and the created contents to the server; and transmitting a message including the storage location information and the access authorization information from a first user terminal apparatus to a second user terminal apparatus.

According to an exemplary embodiment, a contents sharing method of a server may include receiving contents, storage location information corresponding to a location in the server where the contents will be stored and access authorization information for accessing the contents from a first user terminal apparatus; storing the contents in a location in the server corresponding to the storage location information; and transmitting the contents to a second user terminal apparatus, when the second user terminal apparatus accesses the contents using the storage location information and the access authorization information.

According to an exemplary embodiment, a contents sharing method of a user terminal apparatus for downloading contents may include receiving, from a first user terminal apparatus, a message comprising storage location information corresponding to a location in a server where uploaded contents are stored and access authorization information for accessing the uploaded contents; accessing the contents uploaded to the server using the storage location information and the access authorization information; and downloading the accessed contents to a second user terminal apparatus, and the message including the storage location information and the access authorization information is created in the first user terminal apparatus.

According to an exemplary embodiment, a user terminal apparatus for uploading contents may include a contents creator configured to create contents; a communicator configured to upload the created contents on a server, and to receive storage location information corresponding to a location in the server where the uploaded contents are stored and access authorization information for accessing the uploaded contents; and a controller configured to control the communicator to transmit a message comprising the storage location information and the access authorization information from the user terminal apparatus to a second user terminal apparatus.

In addition, the storage location information may be uniform resource locater information corresponding to the location in the server where the uploaded contents are stored.

Furthermore, the message may be transmitted to the user terminal apparatus for downloading contents in at least one from among a multimedia messaging service message, a short messaging service message, an instant message, and an e-mail message.

According to an exemplary embodiment, a server may include a communicator configured to receive contents from a first user terminal apparatus; a storage configured to store the received contents; an information creator configured to generate storage location information corresponding to a location in the server where the received contents are stored and access authorization information for accessing the received contents; and a controller configured to control the communicator to transmit the storage location information and the access authorization information to the first user terminal apparatus, and the controller may control the communicator to receive the storage location information and the access authorization information from a second user terminal apparatus which receives the storage location information and the access authorization information from the first user terminal apparatus and to transmit the received contents to the second user terminal apparatus in response to receiving the storage location information and the access authorization information from the second user terminal apparatus.

In addition, the storage may be configured to classify and store the received contents based on contents subject, contents type, or user terminal apparatus which uploaded the content, and the information creator may be configured to generate the storage location information corresponding to a location in a server where the received contents are classified and stored and the access authorization information for accessing the classified and stored contents.

According to an exemplary embodiment, a user terminal apparatus for downloading contents may include a communicator configured to receive a message including storage location information corresponding to a location in a server where contents are stored and access authorization information for accessing the contents from a second user terminal apparatus; and a controller configured to control the communicator to access the contents uploaded by the second user terminal apparatus to the server and to download the contents to the user terminal apparatus by using the storage location information and the access authorization information.

In addition, the controller may be configured to access the location in the server where the contents are stored by using the storage location information and by transmitting the access authority information to the server.

According to an exemplary embodiment, a user terminal apparatus for uploading contents may include a communicator; a contents creator configured to create contents; an information creator configured to generate storage location information corresponding to a location in a server where the created contents will be stored and access authorization information for accessing the created contents; and a controller configured to combine the storage location information and the access authorization information with the created contents and upload the combined storage location information, the access authority information and the created contents to the server, and to control the communicator to transmit a message including the storage location information and the access authorization information from a user terminal apparatus to a second user terminal apparatus.

According to an exemplary embodiment, a server may include a communicator configured to receive contents, storage location information corresponding to a location in the server where the contents will be stored and access authorization information for accessing the contents from a first user terminal apparatus; a storage configured to store the received contents in a location in the server corresponding to the storage location information; and a controller configured to control the communicator to transmit the accessed contents to a second user terminal apparatus when the second user terminal apparatus accesses the contents using the storage location information and the access authorization information.

According to an exemplary embodiment, a user terminal apparatus for downloading contents may include a communicator configured to receive a message including storage location information corresponding to a location in a server where uploaded contents are stored and access authorization information for accessing the uploaded contents from a first user terminal apparatus; and a controller configured to control the communicator to access the contents uploaded to the server and to download the accessed contents using the storage location information and the access authorization information, and the message including the storage location information and access authorization information may be created in the first user terminal apparatus.

According to an exemplary embodiment, a contents sharing method of a contents sharing system may include uploading, by a first user terminal apparatus, contents to a server; storing, by the server, the contents; generating, by the server, storage location information corresponding to a location in the server where the contents are stored and access authorization information for accessing the contents; transmitting, by the server, the storage location information and the access authorization information to the first user terminal apparatus; transmitting, by the first user terminal apparatus, a message comprising the storage location information and the access authorization information received from the server to a second user terminal apparatus; accessing, by the second user terminal apparatus, the contents stored in the server using the storage location information and the access authorization information received from the first user terminal apparatus; and transmitting, by the server, the accessed contents to the second user terminal apparatus.

According to an exemplary embodiment, a contents sharing method of a contents sharing system may include creating, by a first user terminal apparatus, contents; generating, by the first user terminal apparatus, storage location information corresponding to a location in a server where the created contents will be stored and access authorization information for accessing the created contents; combining, by the first user terminal apparatus, the storage location information and the access authorization information with the contents and uploading the combined storage location information, the access authority information and the contents to the server; transmitting, by the first user terminal apparatus, a message comprising the storage location information and the access authorization information to a second user terminal apparatus; storing, by the server, the contents in a location in the server corresponding to the storage location information; accessing, by the second user terminal apparatus, the contents stored in the server using the storage location information and the access authorization information received from the first user terminal apparatus; and transmitting, by the server, the contents to the second user terminal apparatus.

According to the aforementioned various exemplary embodiments, a new contents sharing method may be provided.

### BRIEF DESCRIPTION OF THE DRAWINGS

The above and/or other aspects will be more apparent by describing certain exemplary embodiments with reference to the accompanying drawings, in which:

FIG. 1 is a block diagram illustrating a contents sharing system according to an aspect of an exemplary embodiment;

FIG. 2 is a block diagram illustrating a user terminal apparatus for uploading contents according to an aspect of an exemplary embodiment;

FIG. 3 is a block diagram illustrating a server according to an aspect of an exemplary embodiment;

FIG. 4 is a block diagram illustrating a user terminal apparatus for downloading contents according to an aspect of an exemplary embodiment;

FIG. 5 is a view illustrating a method of a user terminal apparatus for downloading contents according to an aspect of an exemplary embodiment;

FIG. 6 is a timing view illustrating a contents sharing method of a contents sharing system according to an aspect of an exemplary embodiment;

FIG. 7 is a block diagram illustrating a contents sharing system according to an aspect of another exemplary embodiment;

FIG. 8 is a block diagram illustrating a user terminal apparatus for uploading contents according to an aspect of another exemplary embodiment;

FIG. 9 is a block diagram illustrating a server according to an aspect of another exemplary embodiment;

FIG. 10 is a block diagram illustrating a user terminal apparatus for downloading contents according to an aspect of another exemplary embodiment;

FIG. 11 is a view illustrating a method in which a user terminal apparatus for uploading contents uploads contents according an aspect of another exemplary embodiment;

FIG. 12 is a timing view illustrating a contents sharing method of a contents sharing system according to an aspect of another exemplary embodiment; and

FIG. 13 is a block diagram specifically illustrating a user terminal apparatus for uploading contents and a user terminal apparatus for downloading contents according to various aspects of exemplary embodiments.

### DETAILED DESCRIPTION OF EXEMPLARY EMBODIMENTS

Certain exemplary embodiments are described in detail below with reference to the accompanying drawings.

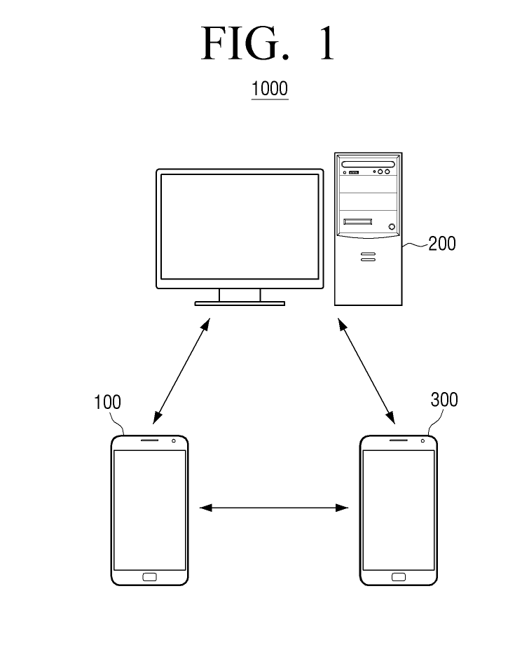

FIGS. 1 to 6 are views for explaining an exemplary embodiment. Hereinbelow is specific explanation of an exemplary embodiment with reference to FIGS. 1 to 6.

FIG. 1 is a block diagram illustrating a contents sharing system according to an exemplary embodiment. With reference to FIG. 1, a contents sharing system 1000 includes a user terminal apparatus for uploading contents 100, server 200, and user terminal apparatus for downloading contents 300.

The user terminal apparatus for uploading contents 100 may create contents. Herein, various kinds of content may be created in the user terminal apparatus 100 such as photograph contents, video contents, and document contents etc. However, for convenience of explanation, herein, contents are described as being a concept including folders where the contents are stored.

When an uploading of the created contents is performed from the user terminal apparatus for uploading contents 100 to the server 200, the server 200 may store the received contents. In addition, the server 200 may create storage location information corresponding to a location in the server where the stored contents are stored and access authorization information for accessing the stored contents. In addition, the server 200 may transmit the created storage location information and access authorization information to the user terminal apparatus for uploading contents 100. Herein, the storage location information is preferably storage location information at the storage 220 included in the server 200. However, for convenience of explanation, herein, the storage location information corresponding to the location stored in the server refers to the storage location information at the storage 220 included in the server 200.

Herein, the storage location information may be Uniform Resource Locator (URL) information corresponding to a location in the server where the uploaded contents are stored.

In addition, the access authorization information may be an access number for accessing the stored contents.

When the storage location information and access authorization information are transmitted from the server 200 to the user terminal apparatus for uploading contents 100, the user terminal apparatus for uploading contents 100 may receive storage location information and access authorization information from the server 200. In addition, the user terminal apparatus for uploading contents 100 may create a message including the received storage location information and access authorization information. Furthermore, the user terminal apparatus for uploading contents 100 may transmit the created message to the user terminal apparatus for downloading contents 300.

Herein, the message may be transmitted to the user terminal apparatus for downloading contents in a Multimedia Messaging Service (MMS), a short messaging service (SMS), Instant Message, and E-mail format.

When the message including the storage location information and access authorization information are transmitted from the user terminal apparatus for uploading contents 100 to the user terminal apparatus for downloading contents 300, the user terminal apparatus for downloading contents 300 may receive the message including the storage location information and access authorization information. The user terminal apparatus for downloading contents 300 may then access the contents stored in the server 200 using the received storage location information and access authorization information. When the access is performed, the user terminal apparatus for downloading contents may download the accessed contents.

Herein, the user terminal apparatus for uploading contents 100 and the user terminal apparatus for downloading contents 300 may be embodied in one of various apparatuses such as a mobile phone, smart phone, tablet computer, notebook computer, Personal Digital Assistant (PDA), Portable Multimedia Player (PMP), navigation, and digital TV, etc.

Furthermore, the server 200 may be a cloud server.

In explaining a contents sharing system according to an exemplary embodiment, the message was explained to be created in the user terminal apparatus 100 for uploading contents, but is not limited thereto, and thus the message may be created in the server 200 instead. In this case, the server 200 may transmit the message to the user terminal apparatus for uploading contents 100, and the user terminal apparatus for uploading contents 100 may forward the received message to the user terminal apparatus for downloading contents 100.

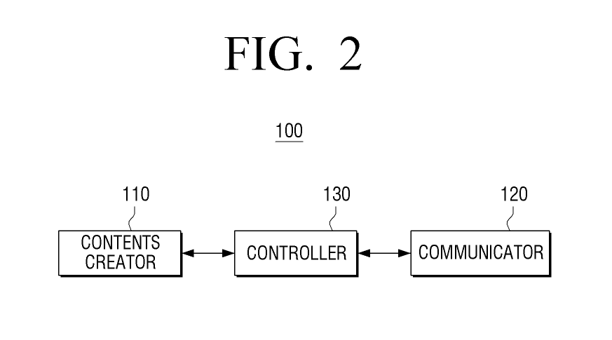

FIG. 2 is a block diagram illustrating a user terminal apparatus for uploading contents according to an exemplary embodiment. With reference to FIG. 2, the user terminal apparatus for uploading contents 100 includes one or more of a contents creator 110, communicator 120, and controller 130.

The contents creator 110 creates contents. Herein, the contents may be one of various contents that may be created in the user terminal apparatus for uploading contents such as photograph contents, video contents, and document contents, etc.

For example, the contents creator 110 may execute a photographing application and drive a camera to create a photograph contents or video contents. In addition, the contents creator 110 may execute a document writing application to create document contents.

That is, the contents creator 110 may create various contents using various applications installed in the user terminal apparatus for uploading contents 100.

The communicator 120 performs a function of connecting the user terminal apparatus for uploading contents 100 with an external apparatus. The communicator 120 may upload contents created in the contents creator 110 onto the server 200.

In addition, the communicator 120 may receive storage location information corresponding to a location in the server 200 where contents are stored and access authorization information for accessing the contents stored in the server 200 from the server 200.

Herein, the storage location information and access authorization information may be received from the server 200 automatically after uploading. In this case, the received storage location information may be storage location information corresponding to a location in the server where the uploaded contents are stored, and the access authorization information may be authorization information for accessing the uploaded contents.

In addition, the storage location information and access authorization information may be manually received from the server 200, as the user terminal apparatus 100 for uploading contents 100 transmits an information request signal 200 to the server 200. That is, the display (not illustrated) may display the contents stored in the server 200, and the user may select the contents to be transmitted to the user terminal apparatus for downloading contents 300 from among the displayed contents. In this case, the controller 130 may create an information request signal regarding the selected contents, and the communicator 120 may transmit the created information request signal to the server 200. In this case, the server 200 may transmit storage location information corresponding to a location in the server 200 where the selected contents are stored and access authorization information for accessing the selected contents to the user terminal apparatus for uploading contents 100. In this case, the received storage location information is storage location information corresponding to the location in the server 200 where the selected contents are stored, and the access authorization information may be authorization information for accessing the selected contents.

In addition, the communicator 120 may transmit a message including the received storage location information and access authorization information to the user terminal apparatus for downloading contents 300.

Herein, the communicator 120 functions to connect the user terminal apparatus for uploading contents 100 with an external apparatus, and may be accessed wirelessly or wiredly through one or more of a short distance communication network such as a Local Area Network (LAN), an internet, a Universal Serial Bus (USB) port, a mobile communication network such as 3G and 4G, Bluetooth, Near Field Communication (NFC), Radio Frequency Identification (RFID), and Zigbee etc.

The controller 130 controls the overall operations of the user terminal apparatus for uploading contents 100. More specifically, the controller 130 may control one or more of the contents creator 110 and the communicator 120.

When contents are created in the contents creator 110, the controller 130 may control the communicator 120 to upload the created contents manually or automatically. More specifically, when new contents are created, the controller 130 may automatically perform synchronization with the server 200, and control the communicator 120 to automatically upload the created new contents. Otherwise, the controller 130 may control the communicator 120 to manually upload the contents selected by the user through a User Interface (UI) window displayed on the display (not illustrated) from among the created contents.

When storage location information corresponding to the location in the server 200 where the contents uploaded onto the server 200 is stored and access authorization information for accessing the uploaded contents are received from the server 200, the controller 130 may control the display (not illustrated) to display the received storage location information and access authorization information.

In addition, the controller 130 may create an information request signal for requesting the storage location information and access authorization information on the selected contents from among the contents stored in the server 200. That is, the display (not illustrated) may display the contents stored in the server 200, and the user may select the contents to be transmitted to the user terminal apparatus for downloading contents 300 from among the displayed contents. In this case, the controller 130 may create an information request signal regarding the selected contents, and the communicator may transmit the created information request signal to the server 200. The server 200 may transmit the storage location information corresponding to the location in the server 200 where the contents are stored and the access authorization information for accessing the uploaded contents selected in the user terminal apparatus for uploading contents 100 to the user terminal apparatus for downloading contents 100. The controller 130 may control the display (not illustrated) to display the received storage location information and access authorization information. However, the exemplary embodiments are not limited thereto, and thus the user may select the folder including the displayed contents as the folder to be transmitted to the user terminal apparatus for downloading contents 300. In this case, the controller 130 may create an information request signal for requesting the storage location information and the access authorization information on the folder stored in the server.

Herein, the storage location information may be URL information corresponding to the location in the server where the uploaded contents are stored. For example, the storage location information may be URL information such as www.pysserver.net/20120113.

In addition, the access authorization information may be an access number for accessing the stored contents. For example, the access number information may be a number such as “ab1234.”

In addition, the controller 130 may create a message including the received storage location information and access authorization information.

In addition, the controller 130 may control the display (not illustrated) to display a UI window for selecting the user terminal apparatus for downloading contents 300 which becomes a receiving subject of the message including the storage location information and access authorization information. In this case, when a contact number and e-mail address etc. of the user terminal apparatus for downloading contents 300 which becomes the receiving subject of the created message is input, the controller 130 may control the communicator 120 to transmit the created message to the user terminal apparatus for downloading contents 300 in one or more of an MMS, Instant Message, and E-mail format.

Herein, the controller 130 may include a CPU, ROM where a control program is stored, and RAM used to remember input data or used as an operation related memory area. The CPU, ROM, and RAM may be mutually connected through an internal BUS.

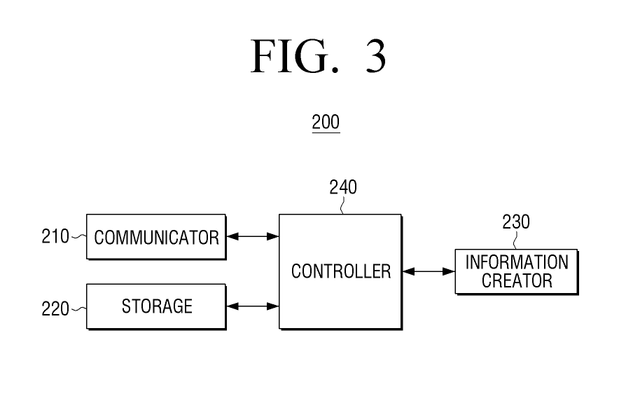

FIG. 3 is a block diagram illustrating a server according to an exemplary embodiment. With reference to FIG. 3, the server 200 includes one or more of a communicator 210, storage 220, information creator 230, and controller 240.

The communicator 210 performs a function of connecting the server 200 with an external apparatus. The communicator 210 may receive contents uploaded from the user terminal apparatus for uploading contents 100.

In addition, the communicator 210 may transmit storage location information corresponding to the location in the server 200 where the contents are stored and access authorization information for accessing the stored contents to the user terminal apparatus for uploading contents 100.

In addition, in the case where the user terminal apparatus for downloading contents 300 accesses the stored contents using the storage location information and access authorization information, the communicator 210 may transmit the accessed contents to the user terminal apparatus for downloading contents 300.

Herein, the communicator 210 functions to connect the server 200 to an external apparatus wirelessly or wiredly through one or more of a short distance communication network, LAN, an internet, a USB port, a mobile communication network such as 3G and 4G, Bluetooth, NFC, RFID, and Zigbee, etc.

The storage 220 performs a function of storing various programs and data necessary in driving the server 200. The storage 220 may store the contents uploaded in the user terminal apparatus for uploading contents 200. Herein, the storage 220 may classify and store the received contents according to a predetermined classification criterion. More specifically, the storage 220 may classify and store the contents uploaded from the user terminal apparatus 100 based on contents subject, contents type, or user terminal apparatus under the control of the controller 240. This will be explained in more detail in the explanation on the controller 240.

The storage 220 may be embodied not only in an embedded type storage device such as a Random Access Memory (RAM), flash memory, Read Only Memory (ROM), Erasable Programmable ROM (EPROM), Electronically Erasable and Programmable ROM (EEPROM), register, hard disk, removable disk, and memory card etc., but also in a detachable type storage device such as a USB memory, and CD-ROM etc.

The information creator 230 may create storage location information corresponding to a location in the server where the contents stored in the storage 220 are stored and access authorization information for accessing the stored contents. More specifically, the information creator 230 may create storage location information corresponding to the location in the server where the contents are classified and stored and access authorization information for accessing the classified and stored contents. This will be explained in more detail in the explanation on the controller 240.

The controller 240 controls the overall operations of the server 200. More specifically, the controller 240 may control one or more of the communicator 210, storage 220, and information creator 230.

The controller 240 may control the storage 220 to classify and store the uploaded contents according to the predetermined criteria. More specifically, the controller 240 may control the storage 220 to classify and store the contents uploaded from the user terminal apparatus for uploading contents 100 in each contents, contents type, or user terminal apparatus for uploading contents etc. Herein, the predetermined criteria may be set together with an upload in the user terminal apparatus for uploading contents 100, or preset in the server 200.

For example, assuming that the predetermined classification criteria is to classify per each contents, and the uploaded contents are ‘photo contents 1’, ‘photo contents 2’, ‘video contents 1’, the controller 240 may control the storage 220 to determine each of the uploaded contents per separate subject, and to classify and store the uploaded contents in ‘photo contents 1’, ‘photo contents 2’, and ‘photo contents 3’.

In addition, assuming that the predetermined classification criteria is to classify per contents type, and the uploaded contents are ‘photo contents 1’, ‘photo contents 2’, ‘video contents 1’, the controller 240 may control the storage 220 to classify and store ‘photo contents 1’ and ‘photo contents 2’ in photo contents type, and to classify and store ‘video contents 1’ in video contents type. In this case, ‘photo contents 1’ and ‘photo contents 2’ may be stored in the photo contents folder, and ‘video contents 1’ may be stored in the video contents folder.

Furthermore, assuming that the predetermined classification criteria is to classify per user terminal apparatus for uploading contents, and the uploaded contents are uploaded from the ‘user terminal apparatus for uploading contents 1’ and ‘user terminal apparatus for uploading contents 2’, the controller 240 may control the storage 220 to determine using the serial number of the user terminal apparatus, telephone number of the user terminal apparatus, and ID input during an upload, etc. to determine the user terminal apparatus for uploading contents, and to classify and store the uploaded contents in ‘contents uploaded from the user terminal apparatus for uploading contents 1’, and ‘contents uploaded from the user terminal apparatus for uploading contents 2’. In this case, the ‘contents uploaded from the user terminal apparatus for uploading contents 1’ may be stored in the folder allocated to the user terminal apparatus for uploading contents 1, and the ‘contents uploaded from the user terminal apparatus for uploading contents 2’ may be stored in the folder allocated the user terminal apparatus for uploading contents 2.

Furthermore, the controller 240 may control the information creator 230 to create the storage location information corresponding to the location where the contents are classified and stored and the access authorization information for accessing the classified and stored contents.

For example, assuming that the predetermined classification criteria is to classify per each contents, and the uploaded contents are ‘photo contents 1’, ‘photo contents 2’, ‘video contents 1’, the uploaded contents are classified and stored in ‘photo contents 1’, ‘photo contents 2’, and ‘photo contents 3’, and the controller 240 may create storage location information corresponding to the location where the ‘classified photo contents 1’ are stored, that is www.pysserver.net/20120113/imageljpg, and the access authorization information for accessing the ‘classified photo contents 1’, that is “ab1111.” In addition, the controller 240 may create storage location information corresponding to the location where the ‘classified photo contents 2’ are stored, that is “www.pysserver.net/20120113/image2.jpg”, and the access authorization information for accessing the ‘classified photo contents 2’, that is “ab2222.” In addition, the controller 240 may create storage location information corresponding to the location where the ‘classified photo contents 3’ are stored, that is www.pysserver.net/20120113/movie3.jpg, and the access authorization information for accessing the ‘classified photo contents 3’, that is “ab3333.” That is, the controller 240 may create location information and access authorization information per each contents subject.

In addition, assuming that the predetermined classification criteria is to classify per contents type, and the uploaded contents are ‘photo contents 1’, ‘photo contents 2’, ‘video contents 1’, of the uploaded contents, ‘photo contents 1’ and ‘photo contents 2’ may be classified and stored in the ‘photo contents folder’, and ‘video contents 1’ may be classified and stored in ‘video contents folder’, and the controller 240 may create storage location information corresponding to the location where the ‘photo contents folder’ are stored, that is “www.pysserver.net/image”, and the access authorization information for accessing the ‘photo contents folder’, that is “ab1111.” In addition, the controller 240 may create storage location information corresponding to the location where the ‘video contents folder’ are stored, that is www.pysserver.net/movie, and the access authorization information for accessing the ‘video contents folder’, that is “ab2222.” That is, the controller 240 may create location information where the classified folder is stored and access authorization information for accessing the classified folder.

In addition, assuming that the predetermined classification criteria is to classify per user terminal apparatus for uploading contents, and the uploaded contents are uploaded from the ‘user terminal apparatus for uploading contents 1’ and ‘user terminal apparatus for uploading contents 2’, the contents uploaded from the ‘user terminal apparatus for uploading contents 1’ may be stored in the ‘folder allocated to the user terminal apparatus for uploading contents 1’, and the contents uploaded from the ‘user terminal apparatus for uploading contents 2’ may be stored in the ‘folder allocated to the user terminal apparatus for uploading contents 2’, and the controller 240 may create storage location information corresponding to the location where the ‘folder allocated to the user terminal apparatus for uploading contents 1’ are stored, that is www.pysserver.net/user1, and the access authorization information for accessing the ‘photo contents folder’, that is “ab1111.” In addition, the controller 240 may create storage location information corresponding to the location where the ‘folder allocated to the user terminal apparatus for uploading contents 2’ are stored, that is “www.pysserver.net/user2”, and the access authorization information for accessing the ‘photo contents folder’, that is “ab2222.”

In addition, when an upload of the user terminal apparatus for uploading contents 100 is performed, the controller 240 may control the communicator 210 to automatically transmit the storage location information and access authorization information. In this case, the transmitted storage location information may be storage location information corresponding to the location in the server 200 where the uploaded contents are stored, and the access authorization information may be access authorization information for accessing the uploaded contents.

Furthermore, when an information request signal is received from the user terminal apparatus for uploading contents 100, the controller 240 may control the communicator 210 to automatically transmit the storage location information and access authorization information. In this case, the transmitted storage location information may be storage location information corresponding to the location in the server 200 where the contents selected in the user terminal apparatus for uploading contents are stored, and the access authorization information may be access authorization information for accessing the contents selected in the user terminal apparatus 100.

In addition, when the user terminal apparatus for downloading contents 300 accesses the stored contents using the storage location information and access authorization information, the controller 240 may control the communicator 210 to transmit the contents accessed to the user terminal apparatus for downloading contents 300. For example, when the user terminal apparatus for downloading contents 300 accesses the address www.pysserver.net/image and transmits the access authorization information “ab111”, “the controller 240 may determine whether or not the received access authorization information “ab1111” is access authorization information for accessing www.pysserver.net/image. If it is determined that “ab1111” is an accessible access authorization information, the controller 240 may control the communicator 210 to allow the user terminal apparatus for downloading contents 300 to access www.pysserver.net/image and to transmit the contents accessed to the user terminal apparatus for downloading contents 300. If it is determined that “ab1111” is a non-accessible access authorization information, the controller 240 may control the communicator 210 to notify the user terminal apparatus for downloading contents 300 that it is non-accessible.

Herein, the controller 240 may include a CPU, ROM where a control program is stored, and RAM used to remember input data or used as an operation related memory area. Herein, the CPU, ROM, and RAM may be mutually connected through an internal BUS.

In explaining FIG. 3, the information creator 230 and controller 240 were explained to be separate configurations, but instead of having an additional information creator 230, it is also possible to configure such that the controller 240 performs the functions of the information creator 230.

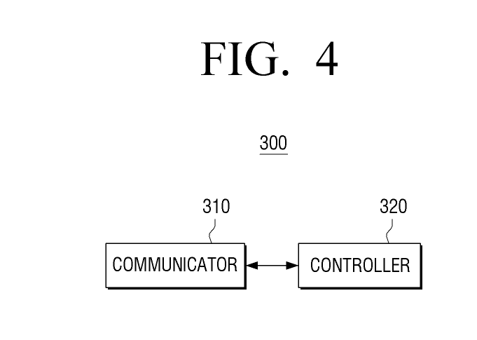

FIG. 4 is a block diagram illustrating a user terminal apparatus for downloading contents according to an exemplary embodiment. With reference to FIG. 4, the user terminal apparatus for downloading contents includes one or more of the communicator 310, and controller 320.

The communicator 310 performs a function of connecting the user terminal apparatus for downloading contents 100 with an external apparatus. The communicator 310 may receive a message including the storage location information corresponding to the location in the server where contents are stored and access authorization information for accessing the contents from the user terminal apparatus for uploading contents 100.

In addition, the communicator 310 may access the contents uploaded on the server using the received storage location information and access authorization information, and download the accessed contents.

Herein, the communicator 310 functions to connect the user terminal apparatus for downloading contents 300 with an external apparatus wirelessly or wiredly through a short distance communication network such as a LAN, an internet, a USB port, a mobile communication network such as 3G and 4G, Bluetooth, NFC, RFID, and Zigbee, etc.

The controller 320 controls the overall operations of the user terminal apparatus for downloading contents 300. More specifically, the controller 320 may control the display (not illustrated) to display the message received from the user terminal apparatus for uploading contents 100. Herein, the displayed message may include the storage location information corresponding to the location in the server where the contents are stored and access authorization information for accessing the contents.

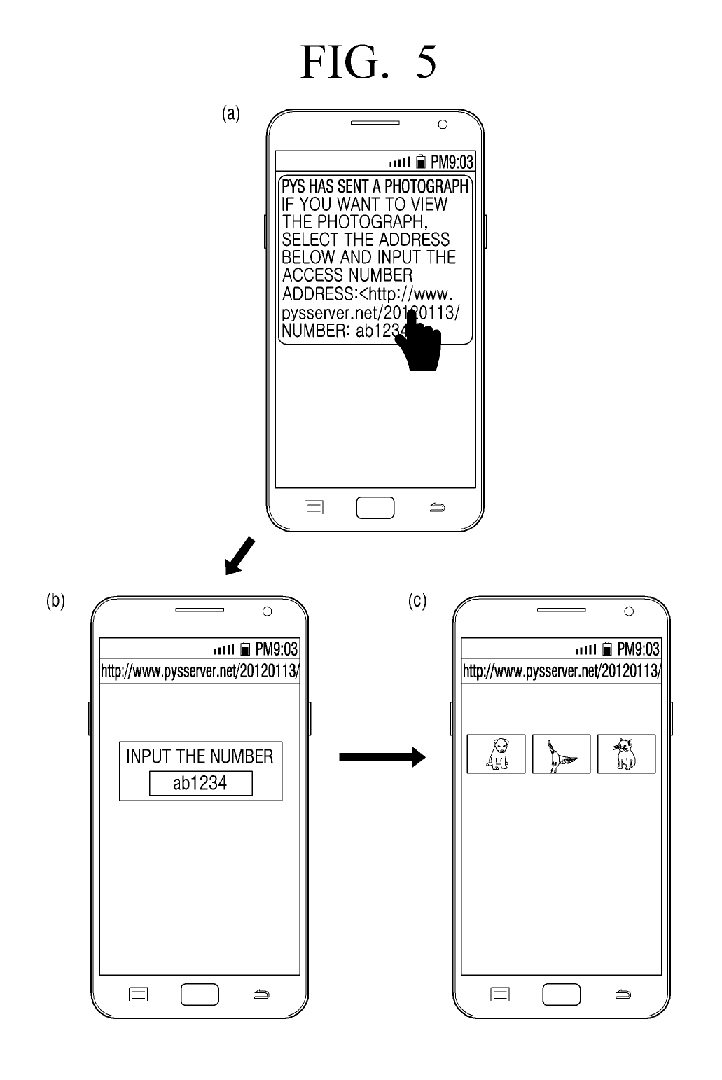

In addition, the controller 320 may control the communicator 310 to access the contents stored in the server using the received storage location information and access authorization information. Herein, an access may be performed by controlling to access the location in the server where the contents are stored using the received storage location information and to transmit the received access authorization information to the server 200. In addition, the controller 320 may control the communicator 310 to download the accessed contents. This will be explained in more detail with reference to FIG. 5.

FIG. 5 is a view illustrating a method of a user terminal apparatus for downloading contents according to an exemplary embodiment.

With reference to FIG. 5(a), the received message may include www.pysserver.net/20120113 as the storage location information, and include “ab1234” as the access authorization information. In this case, when the user enters or touches www.pysserver.net/image to the address window, the controller 320 may control the communicator 310 to access the address.

Accordingly, when the above address is accessed, as in FIG. 5(b), an access authorization information input window may be displayed. In addition, when the user inputs “ab1234” in the created access authorization information input window, the controller 320 may control the communicator 310 to transmit the input access authorization information to the server 200.

When “ab1234” is accessible access authorization information, as in FIG. 5(c), the user terminal apparatus for downloading contents 300 may access the contents stored in the above address. In addition, when the user selects downloading of the accessed contents, the controller 320 may control the communicator 310 to down the accessed contents.

When the controller 320 succeeds in the access, it may control the display (not illustrated) to display a screen that an access has succeeded. In addition, when the “ab1234” is a non-accessible authorization information, the controller 320 may control the display (not illustrated) to display a screen that an access is not possible.

Herein, the controller 320 may include a CPU, ROM where a control program is stored, and RAM used to remember input data or used as an operation related memory area. Herein, the CPU, ROM, and RAM may be mutually connected through an internal BUS.

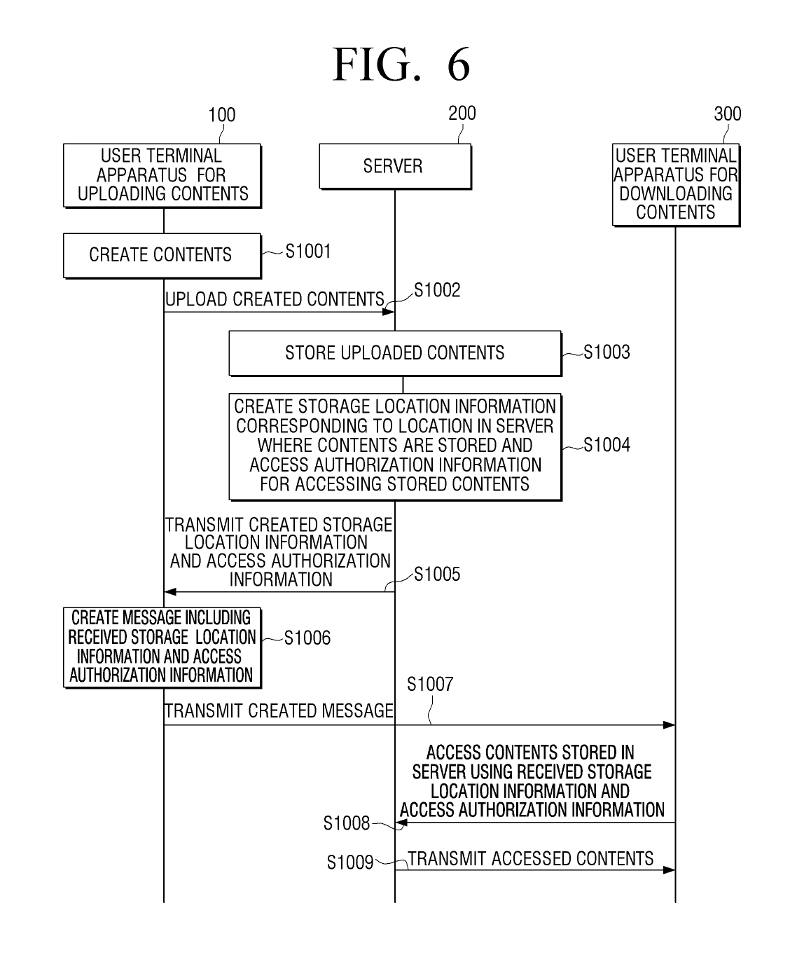

FIG. 6 is a timing view illustrating a contents sharing method of a contents sharing system according to an exemplary embodiment. With reference to FIG. 6, the user terminal apparatus for uploading contents 100 creates contents (Operation S1001). In addition, the user terminal apparatus for uploading contents 100 uploads the created contents to the server (Operation S1002).

In this case, the server 200 stores the contents received according to the uploading (Operation S1003). In addition, the server 200 creates storage location information corresponding to the location in the server where the contents are stored and access authorization information for accessing the stored contents (Operation S1004). In addition, the server 200 transmits the created storage location information and access authorization information to the user terminal apparatus for uploading contents 100 (Operation S1005).

In this case, the user terminal apparatus for uploading contents 100 creates a message including the received created storage location information and access authorization information (Operation S1006). In addition, the user terminal apparatus for uploading contents 100 transmits the created message to the user terminal apparatus for downloading contents 300 (Operation S1007).

In this case, the user terminal apparatus for downloading contents 300 accesses the contents stored in the server 200 using the received created storage location information and access authorization information (Operation S1008).

In this case, the server 200 transmits the contents accessed from the user terminal apparatus for downloading contents 300 (Operation S1009). Accordingly, the user terminal apparatus for downloading contents 300 may download the accessed contents.

In explaining the contents sharing system according to an exemplary embodiment, it was explained that a message is created in the user terminal apparatus for uploading contents 100, however it is not limited thereto, and thus a message including the storage location information and access authorization information may be created in the server 200. In this case, the server 200 may transmit the message to the user terminal apparatus for uploading contents 100, and the user terminal apparatus for uploading contents 100 may forward the received message to the user terminal apparatus for uploading contents 100.

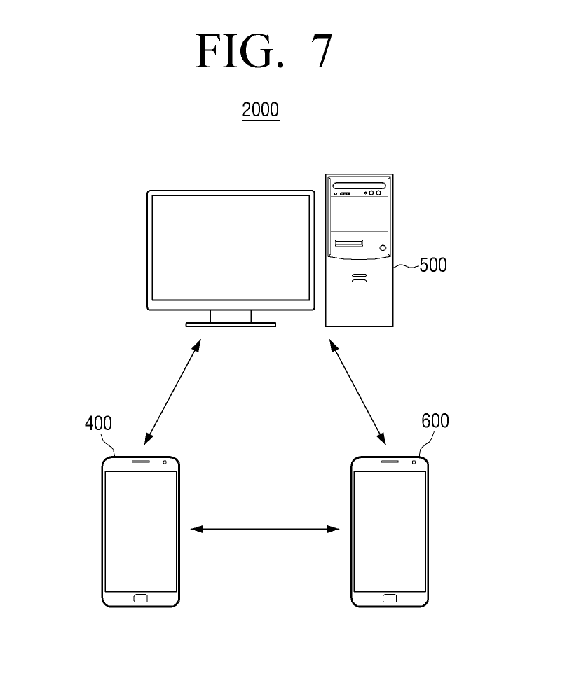

FIGS. 7 to 12 are views for explaining another exemplary embodiment. Hereinbelow is specific explanation of another exemplary embodiment with reference to FIGS. 7 to 12. However, in explaining another exemplary embodiment, specific explanation on the configuration already explained above will be omitted.

FIG. 7 is a block diagram illustrating a contents sharing system according to another exemplary embodiment. With reference to FIG. 7, the contents sharing system 2000 includes a user terminal apparatus for uploading contents 400, server 500, and user terminal apparatus for downloading contents 600.

The user terminal apparatus for uploading contents 400 may create contents. In addition, the user terminal apparatus for uploading contents 400 may create storage location information corresponding to the location in the server where the created contents will be stored and access authorization information for accessing the created contents. Further, the user terminal apparatus for uploading contents 400 may add the created storage location information and access authorization information to the created contents. In addition, the user terminal apparatus for uploading contents 400 may upload the contents created according to the adding onto the server 500. The user terminal apparatus for uploading contents 400 may transmit a message including the created storage location information and access authorization information to the user terminal apparatus for downloading contents 600.

When an upload is performed in user terminal apparatus for uploading contents 400, the server 500 may receive the contents to which the storage location information corresponding to the location in the server where the contents will be stored and access authorization information has been added from the user terminal apparatus for uploading contents 400. In addition, the server 500 may store the received contents in the location in the server corresponding to the storage location information.

When a message is transmitted from the user terminal apparatus for uploading contents 400, the user terminal apparatus for downloading contents 600 may receive a message including storage location information corresponding to the location in the server where the uploaded contents are stored and access authorization information for accessing the uploaded contents from the user terminal apparatus for uploading contents 400. The user terminal apparatus for downloading contents 600 may access the contents uploaded on the server 500 using the received storage location information corresponding and access authorization information. In addition, the user terminal apparatus for downloading contents 600 may download the contents accessed.

Herein, in that the contents created in the user terminal apparatus for downloading contents 400 creates the storage location information corresponding to the location in the server where the created contents will be stored and access authorization information for accessing the created contents, the contents sharing system according to another exemplary embodiment is different from an exemplary embodiment which creates the aforementioned information from the server.

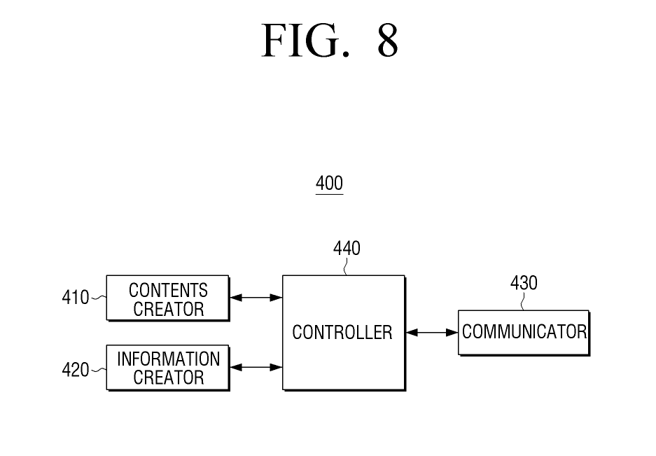

FIG. 8 is a block diagram illustrating a user terminal apparatus for uploading contents according to another exemplary embodiment. With reference to FIG. 8, the user terminal apparatus for uploading contents 400 includes one or more of a contents creator 410, information creator 420, communicator 430, and controller 440.

The contents creator 410 may create various contents using various applications installed in the user terminal apparatus for uploading contents 400.

The contents creator 420 creates storage location information corresponding to the location in the server where the contents will be stored and access authorization information for accessing the contents. Herein, the information creator 420 may create the storage location information and access authorization information manually or automatically.

More specifically, the display (not illustrated) may display a UI window for receiving an input of storage location information corresponding to the location in the server where the contents will be stored and access authorization information for accessing the contents. The user may input the storage location information and access authorization information in a UI window. In this case, the information creator 420 may manually create the storage location information and access authorization information using the input information.

In addition, the information creator 420 may automatically create the storage location information and access authorization information. More specifically, the information creator 420 may create storage location information corresponding to the location in the server where the automatically created contents will be stored using the information on the storage area. Herein, the information on the storage area of the server 500 refers to information on the address to which the storage area of the server is allocated. Such information on the storage area of the server 500 may be pre-stored in the user terminal apparatus for uploading contents 400 or may be received from the server 500 and be stored. In addition, the information creator 420 may automatically create access authorization information using various random variable generation algorithms.

The communicator 430 performs a function of connecting the user terminal apparatus for uploading contents 400 with an external apparatus. The communicator 430 may upload the contents to which the storage location information and access authorization information created in the information creator 420 are added, on the server 500.

In addition, it is possible to transmit the message including the storage location information and access authorization information created in the information creator 420 to the user terminal apparatus for downloading contents 600.

The controller 440 controls the overall operations of the user terminal apparatus for uploading contents 400. More specifically, the controller 440 may control one or more of the contents creator 410, information creator 420, and communicator 430.

The controller 440 may control the display (not illustrated) to display a UI window for receiving a selection of the contents to be uploaded on the server 500 from among the created contents.

In addition, when contents to be uploaded are selected, the controller 440 may control the information creator 420 to create storage location information corresponding to the location in the server where the selected contents will be stored and access authorization information for accessing the selected contents.

In addition, the controller 440 may control the communicator 430 to add the storage location information and access authorization information created in the information creator 420 to the contents to be uploaded and upload the contents.

In addition, the controller 440 may control the communicator 430 to transmit the message including the storage location information and access authorization information created in the information creator 420 to the user terminal apparatus for downloading contents 600.

In explaining FIG. 8, the information creator 420 and controller 440 were explained to be separate configurations, but instead of having an additional information creator 420, it is also possible to configure a user terminal for uploading contents 400 such that the controller 440 performs the functions of the information creator 420.

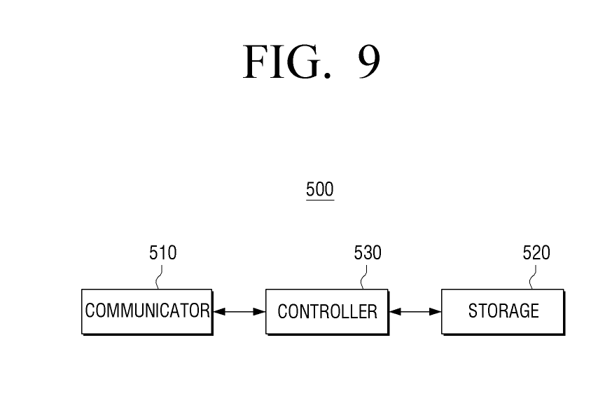

FIG. 9 is a block diagram illustrating a server according to another exemplary embodiment. With reference to FIG. 9, the server 500 includes one or more of the communicator 510, storage 520, and controller 530.

The communicator 510 performs a function of connecting the server with an external apparatus. The communicator 510 may receive a message including the storage location information corresponding to the location in the server where contents will be stored and access authorization information for accessing the contents from the user terminal apparatus for uploading contents 400.

In addition, the communicator 510 may transmit the contents accessed to the user terminal apparatus for downloading contents 600 when the user terminal apparatus for downloading contents 600 accessed the contents stored in the server 500 using the storage location information and access authorization information.

The storage 520 performs a function of storing various data and programs necessary in driving the server 500.

The controller 530 controls the overall operations of the server 500. More specifically, the controller 530 may control one or more of the communicator 510, and storage 520.

The controller 530 may detect the storage location information and access authorization information added to the contents received from the user terminal apparatus for uploading contents 400.

In addition, the controller 530 may control the storage 520 to store the contents received in the location in the server corresponding to the detected storage location information. For example, when the received contents are ‘photo contents 1’, ‘photo contents 2’, and ‘video contents 1’, and the storage location information is www.pysserver.net/20120113, the controller 530 may control the storage 220 to store ‘photo contents 1’, ‘photo contents 2’, and ‘video contents 1’ in the location of www.pysserver.net/20120113. Herein, the access authorization information for accessing www.pysserver.net/20120113 may be access authorization information added to the received contents. In addition, the controller 530 may control the communicator 520 to transmit the contents accessed to the user terminal apparatus for downloading contents in a case where the user terminal for downloading contents 600 accesses the stored contents using the storage location information and access authorization information.

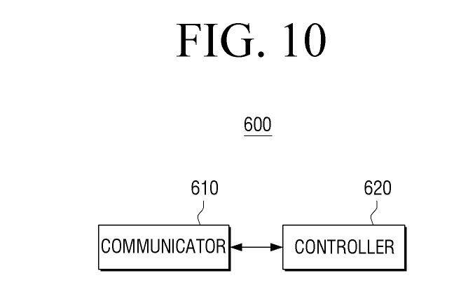

FIG. 10 is a block diagram illustrating a user terminal apparatus for downloading contents according to another exemplary embodiment. With reference to FIG. 10, the user terminal for downloading contents 600 includes one or more of the communicator 610, and controller 620.

Herein, the user terminal for downloading contents 600 according to another exemplary embodiment is similar to that of FIG. 4 except for the fact that the received message is created in the user terminal for uploading contents 400, and thus detailed explanation will be omitted.

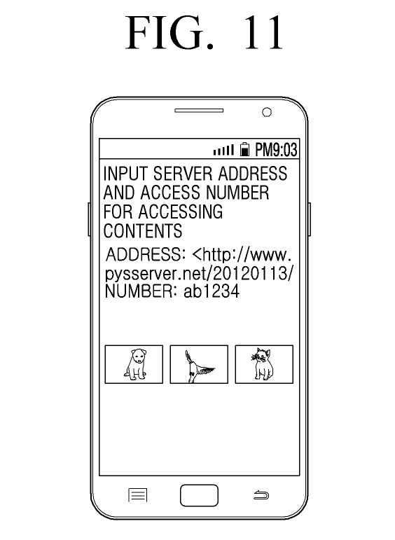

FIG. 11 is a view illustrating a method in which a user terminal apparatus for uploading contents uploads contents according to another exemplary embodiment. With reference to FIG. 11, the display (not illustrated) may display a UI window for receiving an input of storage location information corresponding to the location in the server where the contents will be stored and access authorization information for accessing contents. In this case, the user may input www.pysserver.net/20120113 as the storage location information and input “ab1234” as the access authorization information on the UI window. In this case, the information creator 420 may manually create storage location and access authorization information using the input information.

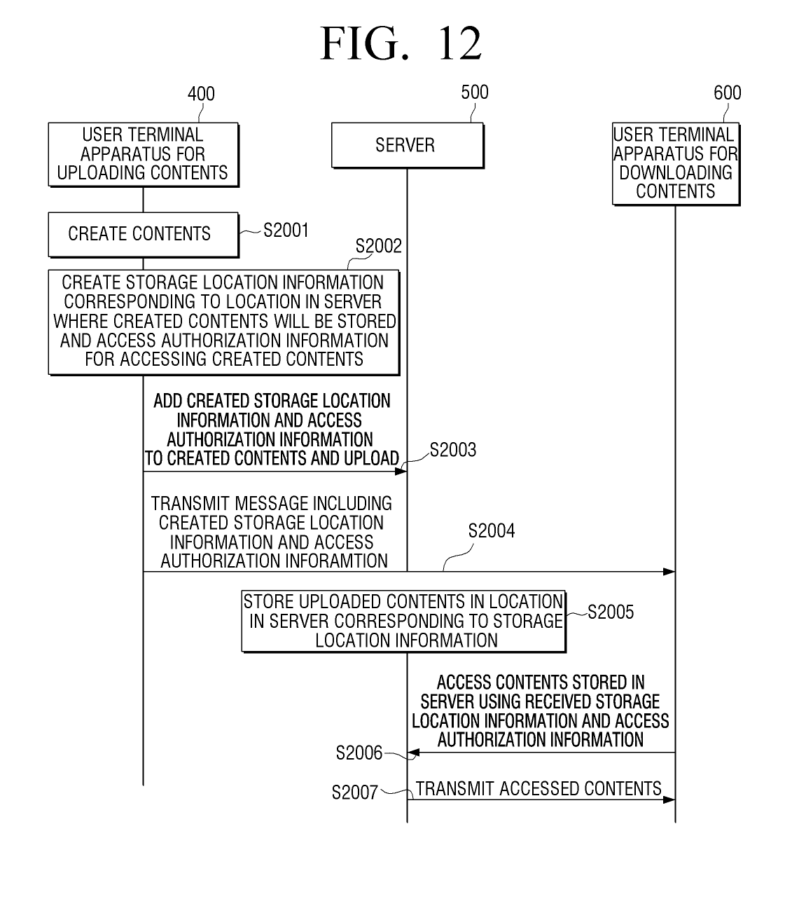

FIG. 12 is a timing view illustrating a contents sharing method of a contents sharing system according to another exemplary embodiment. With reference to FIG. 12, the user terminal apparatus for uploading contents 400 creates contents (Operation S2001). In addition, the user terminal apparatus for uploading contents 400 creates storage location information corresponding to the location in the server where the created contents will be stored and access authorization information for accessing the created contents (Operation S2002). The user terminal apparatus for uploading contents 400 adds the created storage location information and access authorization information to created contents and uploads the information to the server 500 (Operation S2003). The user terminal apparatus for uploading contents 400 transmits a message including the created storage location information and access authorization information to the user terminal apparatus for downloading contents 600 (Operation S2004).

In this case, the server 500 stores the uploaded contents in the location in the server corresponding to the received storage location information (Operation S2005).

In addition, the user terminal apparatus for downloading contents 600 accesses the contents uploaded on the server 500 using the received storage location information and access authorization information (Operation S2006).

In this case, the server 500 transmits the accessed contents to the user terminal apparatus for downloading contents 600. Accordingly, the user terminal apparatus for downloading contents 600 may download the accessed contents (Operation S2007).

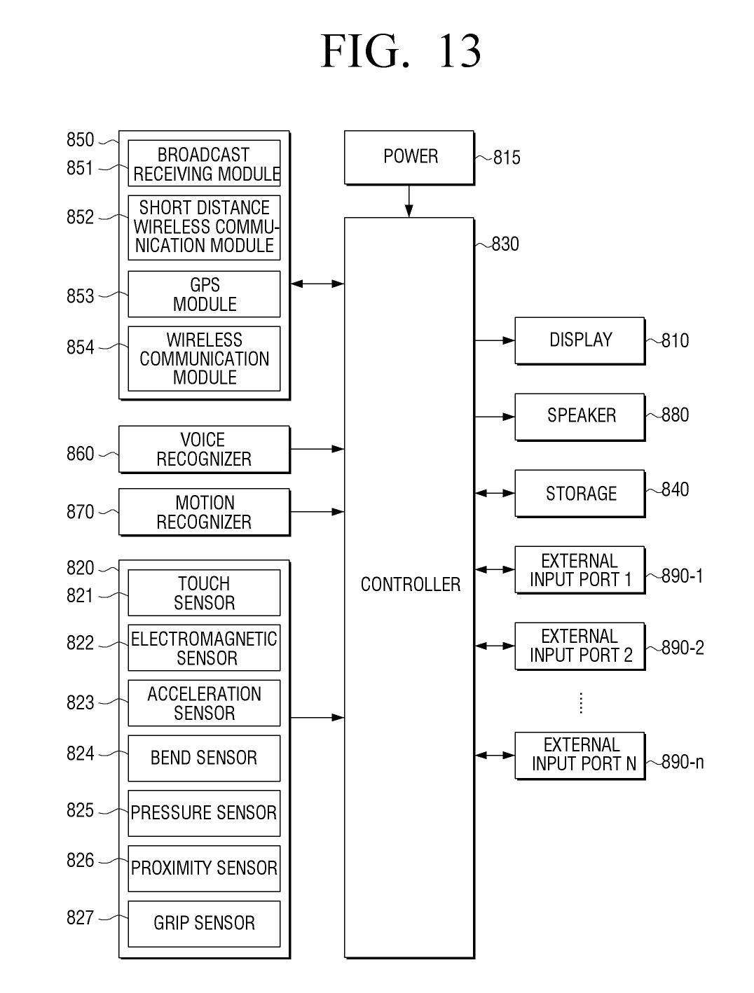

FIG. 13 is a block diagram specifically illustrating a user terminal apparatus for uploading contents and a user terminal apparatus for downloading contents according to various exemplary embodiments. With reference to FIG. 13, the user terminal apparatus 800 includes one or more of the display 810, sensor 820, controller 830, storage 840, communicator 850, voice recognizer 860, motion recognizer 870, speaker 880, external input ports (890-1˜890-n), and power 815.

The display 810 performs a function of displaying a screen. Herein, the display 810 may be embodied in at least one of liquid crystal display, thin film transistor-liquid crystal display, organic light-emitting diode, flexible display, 3D display, and transparent display.

In the storage 840, various programs or data related to operations of the user terminal apparatus 800, setting information set by the user, operating software, various application programs, and information on operations corresponding to user manipulations etc. may be stored.

The sensor 820 senses the overall state of the user terminal apparatus 800 including the display 810. With reference to FIG. 13, the sensor 820 may include various types of sensors such as a touch sensor 821, electromagnetic sensor 822, acceleration sensor 823, bend sensor 824, pressure sensor 825, proximity sensor 826, and grip sensor 827 etc.

The touch sensor 821 may be embodied in a capacitive touch type or a pressure sensitive type. A capacitive touch type sensor uses the dielectric body coated on the surface of the display 810 and senses fine electricity excited by the user's body when a portion of the user's body touches the surface of the display 810. A pressure sensitive type sensor includes two electrode panels and when the user touches the screen, senses the current as upper and lower panels at the touched point contacts each other, and calculates the touch coordinates. As aforementioned, the touch sensor 821 may be embodied in various forms.

An electromagnetic sensor 822 is a sensor for sensing a rotating state or motion direction of the user terminal apparatus 800, and an acceleration sensor 823 is a sensor for sensing the extent of inclination of the user terminal apparatus 800.

A bend sensor 824 may sense a bending state of the user terminal apparatus 800. Such a bend sensor 824 may be included when the display 810 is embodied in a flexible display apparatus.

A pressure sensor 825 senses the size of pressure applied to the user terminal apparatus 800 when the user manipulates the sensor and provides the result to the controller 830. The pressure sensor 825 may include a piezo film configured inside the display 810 to output electrical signals corresponding to the size of the pressure. In FIG. 13, the pressure sensor 825 and the touch sensor 821 are illustrated to be separate sensors, but when the touch sensor 821 is embodied in a pressure sensitive touch sensor, it may also play the role of a pressure sensor 850.

A proximity sensor 826 is a sensor for sensing a motion that does not directly touches but approaches the display surface. The proximity sensor 826 forms a high frequency magnetic field, and may be embodied in one of various types of sensors such as a high frequency active type which senses the current induced by the magnetic field characteristics that changes when an object approaches, a magnetic type which uses magnet, and a capacitance that changes due to an approach by an object.

A grip sensor 827 is a sensor arranged in a circumference or handle portion of the user terminal apparatus 800 separately from the pressure sensor 825, and which senses the user's grip. The grip sensor 827 may be embodied in a pressure sensor or touch sensor.

The controller 830 analyzes various sense signals sensed in the sensor 820, understands the user's intentions, and performs operations corresponding to the intentions. An example of operations performed in the controller 830 may include processing data stored in the storage 840 and outputting the processed data through the display 810 and speaker 880. In this case, the controller 830 may perform communication with external apparatuses using the communicator 850.

The communicator 850 is a configuration of performing communication with various types of external apparatuses according to various types of communication methods. The communicator 850 may include various communication modules such as a broadcast receiving module 851, short distance wireless communication module 852, GPS module 853, wireless communication module 854, etc. Herein, a broadcast receiving module 851 may include a ground wave broadcast receiving module (not illustrated) including an antenna for receiving groundwave broadcast signals, demodulator, and equalizer, and a Digital Multimedia Broadcast (DMB) module for receiving and processing a DMB broadcast signals. A short distance wireless communication module 852 is a module for performing communication with an external apparatus located by a short distance according to a short distance wireless communication method such as NFC, Bluetooth and Zigbee method etc. A GPS module 853 is a module for receiving a GPS signal from a GPS satellite and detecting a current location of the user terminal apparatus 800. A wireless communication module 854 is a module connected to an external network according to a wireless communication protocol such as Wi-Fi, IEEE to perform communication. Besides the above, the communication module 852 may further include mobile communication modules such as 3rd Generation (3G), 3rd Generation Partnership Project (3GPP), and Long Term Evolution (LTE) that accesses a mobile communication network and performs communication according to various mobile communication standards.

The controller 830 may selectively activate configurative elements necessary to perform operations that the user intended from among each configurative element, and perform operations.

The controller 830 may recognize a voice input or motion input besides a bending manipulation or touch manipulation and perform operations corresponding to the input. In this case, the controller 830 may activate the voice recognizer 860 or motion recognizer 870.

The voice recognizer 860 uses voice acquisition devices such as a microphone (not illustrated) to collect a user's voice or external sound and transmits it to the controller 830. When operating in a voice control mode, and when the user's voice is identical to the predetermined voice command, the controller 830 may perform a task corresponding to the user's voice.

A task that is controllable by using voice may include various tasks such as adjusting volume, selecting channel, zapping channel, adjusting channel, adjusting display characteristics, reproducing, temporary stop, rewinding, fast forwarding, executing application, selecting menu, turn on apparatus, turn off apparatus etc.

The motion recognizer 870 may use imaging sensors (not illustrated) such as a camera to obtain the user's image and provides the obtained image to the controller 830. When operating in a motion control mode, and when it is determined after analyzing the user's image that the user is making a motion gesture corresponding to a predetermined motion command, the controller 830 performs the operation corresponding to the motion gesture. For example, various tasks such as zapping channels, turning on apparatus, turning off apparatus, temporary stop, reproducing, stop, rewinding, fast forwarding, mute etc. may be controlled by a motion. The aforementioned examples regarding the tasks that may be controlled by voice, and tasks that may be controlled by motions are just examples and thus are not limited thereto.

Besides, external input ports 1, 2˜n (190-1˜190-n) may be connected to various types of external apparatuses and receive various data, program, or control command etc. More specifically, they may include a USB port, headset port, mouse port, and LAN port etc.

The power 815 is a configurative element for supplying power to each configurative element of the user terminal apparatus 100.

FIG. 13 illustrates that various configurative elements may be included in the user terminal apparatus 800, but it is not that the user terminal apparatus 800 has to include all the configurative elements, and the configurative elements are not limited thereto either. That is, some of the configurative elements may be omitted or added depending on type of the products, and further, they may also be substituted for other configurative elements. In addition, although not illustrated in FIG. 13, in the case of the user terminal apparatus for uploading contents, the aforementioned contents creator and information creator may be additionally included.

The contents sharing method according to various exemplary embodiments may be embodied in a program code and stored in various non-transitory computer readable medium and provided to each server or device.

Although a few exemplary embodiments have been shown and described, it would be appreciated by those skilled in the art that changes may be made to the exemplary embodiments without departing from the principles and spirit of the inventive concept, the scope of which is defined in the claims and their equivalents.

What is claimed is:

1. A contents sharing method of a user terminal apparatus for uploading contents, the method comprising:
creating contents;
uploading the created contents from the user terminal apparatus to a server;
receiving, at the user terminal, storage location information corresponding to a location in the server where the uploaded contents are stored and access authorization information for accessing the uploaded contents from the server; and
transmitting a message comprising the storage location information and the access authorization information from the user terminal apparatus to a second user terminal apparatus.

2. The method according to claim 1,
wherein the storage location information comprises uniform resource locater information corresponding to the location in the server where the uploaded contents are stored.

3. The method according to claim 1,
wherein the message comprises at least one from among a multimedia messaging service message, a short messaging service message, an instant message, and an e-mail message.

4. A contents sharing method of a server, the method comprising:
receiving uploaded contents from a first user terminal apparatus;
storing the received contents;
generating storage location information corresponding to a location in the server where the received contents are stored and access authorization information for accessing the received contents;
transmitting the storage location information and the access authorization information to the first user terminal apparatus;
receiving the storage location information and the access authorization information from a second user terminal apparatus which receives the storage location information and the access authorization information from the first user terminal apparatus; and
transmitting the received contents to the second user terminal apparatus in response to the receiving the storage location information and the access authorization information from a second user terminal apparatus.

5. The method according to claim 4,
wherein the storing classifies and stores the received contents based on contents subject, contents type, or user terminal apparatus which uploaded the contents, and
wherein the generating generates the storage location information corresponding to a location in a server where the received contents are classified and stored, and the access authorization information for accessing the classified and stored contents.

6. A method for sharing contents of a user terminal apparatus for downloading contents, the method comprising:
receiving, at a second user terminal apparatus, a message including storage location information corresponding to a location in a server where contents are stored and access authorization information for accessing the contents from a first user terminal apparatus;
accessing the contents uploaded by the first user terminal apparatus to the server by using the storage location information and the access authorization information; and
downloading the accessed contents.

7. The method according to claim 6,
wherein the accessing is performed by accessing the location in the server where the contents are stored by using the received location information and by transmitting the access authority information to the server.

8. A contents sharing method of a user terminal apparatus for uploading contents, the method comprising:
creating contents;
generating storage location information corresponding to a location in a server where the created contents will be stored and access authorization information for accessing the created contents;
combining the storage location information and the access authority information with the created contents and uploading the combined storage location information, the access authority information and the created contents to the server; and
transmitting a message including the storage location information and the access authorization information from a first user terminal apparatus to a second user terminal apparatus.

9. A contents sharing method of a server, the method comprising:
receiving contents, storage location information corresponding to a location in the server where the contents will be stored and access authorization information for accessing the contents from a first user terminal apparatus;
storing the contents in a location in the server corresponding to the storage location information; and
transmitting the contents to a second user terminal apparatus, when the second user terminal apparatus accesses the contents using the storage location information and the access authorization information.

10. A contents sharing method of a user terminal apparatus for downloading contents, the method comprising:
receiving, from a first user terminal apparatus, a message comprising storage location information corresponding to a location in a server where uploaded contents are stored and access authorization information for accessing the uploaded contents;
accessing the contents uploaded to the server using the storage location information and the access authorization information; and
downloading the accessed contents to a second user terminal apparatus,
wherein the message comprising the storage location information and the access authorization information is created in the first user terminal apparatus.

11. A user terminal apparatus for uploading contents, the apparatus comprising:
a contents creator which is configured to create contents;
a communicator which is configured to upload the created contents on a server, and to receive storage location information corresponding to a location in the server where the uploaded contents are stored and access authorization information for accessing the uploaded contents; and
a controller which is configured to control the communicator to transmit a message comprising the storage location information and the access authorization information from the user terminal apparatus to a second user terminal apparatus.

12. The apparatus according to claim 11,
wherein the storage location information comprises uniform resource locater information corresponding to the location in the server where the uploaded contents are stored.

13. The apparatus according to claim 11,
wherein the message comprises at least one from among a multimedia messaging service message, a short messaging service message, an instant message, and an e-mail message.

14. A server comprising:
a communicator which is configured to receive contents from a first user terminal apparatus;
a storage which is configured to store the received contents;
an information creator which is configured to generate storage location information corresponding to a location in the server where the received contents are stored and access authorization information for accessing the received contents; and
a controller which is configured to control the communicator to transmit the storage location information and the access authorization information to the first user terminal apparatus,
wherein the controller controls the communicator to receive the storage location information and the access authorization information from a second user terminal apparatus which receives the storage location information and the access authorization information from the first user terminal apparatus and to transmit the received contents to the second user terminal apparatus in response to receiving the storage location information and the access authorization information from the second user terminal apparatus.

15. The server according to claim 14,
wherein the storage is configured to classify and store the received contents based on contents subject, contents type, or user terminal apparatus which uploaded the contents, and
wherein the information creator is configured to generate the storage location information corresponding to a location in a server where the received contents are classified and stored and the access authorization information for accessing the classified and stored contents.

16. A user terminal apparatus for downloading contents, the apparatus comprising:
a communicator which is configured to receive a message including storage location information corresponding to a location in a server where contents are stored and access authorization information for accessing the contents from a second user terminal apparatus; and
a controller which is configured to control the communicator to access the contents uploaded by the second user terminal apparatus to the server and to download the contents to the user terminal apparatus by using the storage location information and the access authorization information.

17. The apparatus according to claim 16,
wherein the controller is configured to access the location in the server where the contents are stored by using the storage location information and by transmitting the access authority information to the server.

18. A user terminal apparatus for uploading contents, the apparatus comprising:
a communicator;
a contents creator which is configured to create contents;
an information creator which is configured to generate storage location information corresponding to a location in a server where the created contents will be stored and access authorization information for accessing the created contents; and
a controller which is configured to combine the storage location information and the access authorization information with the created contents and upload the combined storage location information, the access authority information and the created contents to the server, and to control the communicator to transmit a message including the storage location information and the access authorization information from a user terminal apparatus to a second user terminal apparatus.

19. A server comprising:
a communicator which is configured to receive contents, storage location information corresponding to a location in the server where the contents will be stored and access authorization information for accessing the contents from a first user terminal apparatus;
a storage which is configured to store the received contents in a location in the server corresponding to the storage location information; and
a controller which is configured to control the communicator to transmit the accessed contents to a second user terminal apparatus when the second user terminal apparatus accesses the contents using the storage location information and the access authorization information.

20. A user terminal apparatus for downloading contents, the apparatus comprising:
a communicator which is configured to receive a message comprising storage location information corresponding to a location in a server where uploaded contents are stored and access authorization information for accessing the uploaded contents from a first user terminal apparatus; and
a controller which is configured to control the communicator to access the contents uploaded to the server and to download the accessed contents using the storage location information and the access authorization information,
wherein the message comprising the storage location information and access authorization information is created in the first user terminal apparatus.

21. A contents sharing method of a contents sharing system, the method comprising:
uploading, by a first user terminal apparatus, contents to a server;
storing, by the server, the contents;
generating, by the server, storage location information corresponding to a location in the server where the contents are stored and access authorization information for accessing the contents;
transmitting, by the server, the storage location information and the access authorization information to the first user terminal apparatus;
transmitting, by the first user terminal apparatus, a message comprising the storage location information and the access authorization information received from the server to a second user terminal apparatus;
accessing, by the second user terminal apparatus, the contents stored in the server using the storage location information and the access authorization information received from the first user terminal apparatus; and
transmitting, by the server, the accessed contents to the second user terminal apparatus.

22. A contents sharing method of a contents sharing system, the method comprising:
creating, by a first user terminal apparatus, contents;
generating, by the first user terminal apparatus, storage location information corresponding to a location in a server where the created contents will be stored and access authorization information for accessing the created contents;
combining, by the first user terminal apparatus, the storage location information and the access authorization information with the contents and uploading the combined storage location information, the access authority information and the contents to the server;
transmitting, by the first user terminal apparatus, a message comprising the storage location information and the access authorization information to a second user terminal apparatus;
storing, by the server, the contents in a location in the server corresponding to the storage location information;
accessing, by the second user terminal apparatus, the contents stored in the server using the storage location information and the access authorization information received from the first user terminal apparatus; and
transmitting, by the server, the contents to the second user terminal apparatus.

23. A content sharing method of a first user terminal, the method comprising:
receiving, from a server, storage location information of content stored in the server and access authorization information for accessing the content; and
transmitting, to a second user terminal, a message comprising the storage location information and the access authorization information.

24. The method according to claim 23,
wherein the storage location information comprises uniform resource locater information.

25. The method according to claim 23,
wherein the message comprises at least one from among a multimedia messaging service message, a short messaging service message, an instant message, and an e-mail message.
